(19) United States
(12) Patent Application Publication
(10) Pub. No.: US 2020/0204397 A1
(43) Pub. Date: Jun. 25, 2020

(54) RELAY APPARATUS, RELAY METHOD AND RELAY PROGRAM

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Masayuki Inoue, Yokkaichi, Mie (JP)

(21) Appl. No.: 16/614,820

(22) PCT Filed: May 23, 2018
(86) PCT No.: PCT/JP2018/019822

§ 371 Date: Nov. 19, 2019

(30) Foreign Application Priority Data
Jun. 6, 2017 (JP) 2017-111878

(51) Int. Cl. H04L 12/40; H04L 12/66; H04L 12/801

(52) U.S. Cl. CPC H04L 12/40013; H04L 12/40182; H04L 12/66; H04L 2012/40273; H04L 47/29; H04L 2012/40215; H04L 47/13

(57) ABSTRACT

A relay apparatus includes a relay unit to which a plurality of communication lines are connected, and that relays a message received from one communication line, by transmitting the message on another communication line, a switch for switching between a connected state where at least two communication lines included in the plurality of communication lines are connected directly and a separated state where the communication lines are separated apart, and a relay rule switching unit for switching a message relay rule for the relay unit depending on a switching state of the switch. The relay apparatus also includes a communication state detection unit that detects a communication state of the communication lines, and switches the switch in accordance with the communication state detected by the communication state detection unit.

### CROSS-REFERENCE TO RELATED APPLICATIONS

This application is the U.S. national stage of PCT/JP2018/019822 filed on May 23, 2018, which claims priority of Japanese Patent Application No. JP 2017-111878 filed on Jun. 6, 2017, the contents of which are incorporated herein.

### TECHNICAL FIELD

The present disclosure relates to a relay apparatus, a relay method, and a relay program for performing processing for relaying a message transmitted/received between a plurality of communication lines.

### BACKGROUND

JP 2006-287738A proposes a network system in which a gateway node connected to a plurality of CAN (Controller Area Network) buses is aimed to suppress communication delay of important frames, occurrence of reception dropouts, and occurrence of transmission delays of low-priority IDs. In this network system, the gateway node monitors the load states of the CAN buses, and adjusts the bus loads in accordance with the bus load states. Bus load adjustment is performed by the gateway node reducing the relay processing or reducing the data length of a relay frame, another node extending the transmission cycle of frames or reducing the data length of a transmission frame, and the like.

WO 2013/136496 (Re-publication of PCT) proposes a communication apparatus, in which a CAN controller calculates a bus load rate of a network, and a determination is made as to whether the load in the network is high or low based on the bus load rate, and a communication apparatus itself limits transmission of communication messages based on the determination result that the load is high.

In a relay apparatus to which a plurality of communication lines are connected, a communication IC (integrated circuit) or the like for transmitting/receiving messages is provided for each of the communication lines. There is a problem in that the number of communication ICs mounted in the relay apparatus increases as the number of communication lines connected to the relay apparatus increases, and power consumption caused by operating the plurality of communication ICs increases. A similar problem may arise in the network system described in JP 2006-287738A.

In addition, there is the possibility that, for example, by connecting an unauthorized communication apparatus to a communication line, and transmitting a large amount of messages to the communication line, the communication system may be subjected to a malicious attack that hinders transmission/receiving of messages to/from a regular communication apparatus. In the disclosures described in JP 2006-287738A and WO 2013/136496 (Re-publication of PCT), the communication amount is decreased in accordance with the bus load, but it is difficult to cope with an attack of an unauthorized communication apparatus transmitting a large amount of messages.

An object of the present disclosure, made in view of such circumstances, is to provide a relay apparatus and a relay method that can suppress an increase in power consumption caused by operations of communication ICs and the like. Another object of the present disclosure is to provide a relay apparatus, a relay method, and a relay program that can reduce the influence on the entire system from an attack of an unauthorized communication apparatus transmitting a large amount of messages.

### SUMMARY

A relay apparatus according to the present disclosure includes a relay unit to which a plurality of communication lines are connected, and that is configured to relay a message received from one communication line, by transmitting the message on another communication line, a switch for switching between a connected state where at least two communication lines included in the plurality of communication lines are connected and a separated state where the communication lines are separated apart, and a relay rule switching unit for switching a message relay rule for the relay unit depending on a switching state of the switch.

In addition, the relay apparatus according to the present disclosure includes a communication state detection unit configured to detect a communication state of the communication lines, and the switch is switched in accordance with the communication state detected by the communication state detection unit.

In addition, in the relay apparatus according to the present disclosure, the communication state detection unit is configured to detect an amount of messages transmitted/received via the communication lines, and, if the message amount is smaller than a predetermined amount, the switch is switched to the connected state, and if the message amount exceeds the predetermined amount, the switch is switched to the separated state.

In addition, the relay apparatus according to the present disclosure includes a relay prohibition unit configured to prohibit the relay unit from relaying a message received from a communication line for which a message amount detected by the communication state detection unit after the switch has been switched to the separated state exceeds a second predetermined amount, to another communication line.

In addition, the relay apparatus according to the present disclosure includes a storage unit configured to store a plurality of sets of relay information in which a message and a relay destination of the message are associated, and a message relay rule is switched by reading out one set of the relay information from the storage unit configured to store a switching state of the switch.

In addition, in a relay method according to the present disclosure, a relay apparatus, to which a plurality of communication lines are connected, and that relays a message received from one communication line, by transmitting the message on another communication line, switches between a connected state where at least two communication lines included in the plurality of communication lines are connected and a separated state where the communication lines are separated apart, and switches a message relay rule depending on a switching state.

In addition, a relay program according to the present disclosure causes a relay apparatus that includes a relay unit to which a plurality of communication lines are connected, and that relays a message received from one communication line, by transmitting the message on another communication line, and a switch for switching between a connected state where at least two communication lines included in the plurality of communication lines are connected and a separated state where the communication lines are separated apart, to switch the switch depending on a communication state of the communication lines, and to switch a message relay rule for the relay unit depending on a switching state of the switch.

In the present disclosure, a switch is used for switching between a connected state where at least two communication lines included in a plurality of communication lines connected to a relay apparatus are connected directly or a separated state where the communication lines are separated apart. On the directly connected communication lines, a message can be transmitted/received without being relayed by the relay apparatus. Therefore, when a switch is made to the connected state using the switch, a communication IC for transmitting/receiving a message to/from a communication line is not required to operate, and a low-power-consumption state such as a sleep state or a standby state is entered, whereby the power consumption can be reduced. In addition, if the message transmission/receiving amount increases on communication lines that have been switched to the connected state, the communication load can be distributed and reduced by the communication lines being switched to the separated state individually by the switch.

Such connection/separation of communication lines changes the network configuration in the communication system. Therefore, the relay apparatus switches the message relay rule according to the network configuration, in other words the switching state of the switch. For example, the relay apparatus can switch the message relay rule by storing a plurality of pieces of information such as relay information in which a message and a relay destination to which this message is to be relayed are associated, and information such as a so-called routing map or routing table, and relaying the message using one piece of such relay information according to the switching state of the switch.

In addition, in the present disclosure, the communication state of communication lines is detected, and the switch is switched according to the detected communication state. At this time, the relay apparatus detects a common communication state regarding a plurality of communication lines in the connected state, and individually detects communication states regarding communication lines in the separated state. A communication state that is detected can be the amount of messages transmitted/received during a predetermined time period, for example.

For example, the relay apparatus switches the switch to bring a plurality of communication lines into the connected state if the message amount is smaller than a predetermined amount, and bring the communication lines into the separated state if the message amount exceeds the predetermined amount. The power consumption of the communication IC and the like can be reduced by bringing a plurality of communication lines into the connected state if the message amount is small, and the communication load can be distributed and reduced by bringing a plurality of communication lines into the separated state if the message amount is large.

In addition, in the present disclosure, the relay apparatus switches the switch to the separated state based on the message amount exceeding the predetermined amount, and then detects the communication states of the separated communication lines. If there is a communication line for which the detected message amount exceeds a second predetermined amount, the relay apparatus prohibits a message received from this communication line from being relayed to another communication line. Accordingly, if an unauthorized communication apparatus connected to one of the communication lines delivers an attack of transmitting a large amount of messages, it is possible to detach this communication line from the system, and reduce the influence on the entire system. Note that the second predetermined amount may be the same as the predetermined amount that is used as a reference for determination on switching, or may take a different value.

### Advantageous Effects of Disclosure

According to the present disclosure, by providing a switch for switching a plurality of communication lines to a connected state, it is possible to suppress an increase in the power consumption caused by operations of a communication IC and the like. Also, according to the present disclosure, a configuration is adopted in which, if a message amount on a communication line that has been switched to a separated state exceeds a second predetermined amount, relay of a message from this communication line is prohibited, and thereby it is possible to reduce the influence on the entire system from an attack of an unauthorized communication apparatus transmitting a large amount of messages.

### BRIEF DESCRIPTION OF DRAWINGS

FIG. 1 is a schematic diagram illustrating the configuration of a communication system according to an embodiment of the present disclosure.

FIG. 2 is a schematic diagram illustrating the configuration of a gateway.

FIG. 3 is a block diagram illustrating the configuration of a control unit.

FIG. 4 is a schematic diagram illustrating a configuration example of a first routing map.

FIG. 5 is a schematic diagram illustrating a configuration example of a second routing map.

FIG. 6 is a flowchart illustrating a procedure of processing performed by the gateway when communication lines are in a connected state.

FIG. 7 is a flowchart illustrating a procedure of processing performed by the gateway when communication lines are in a separated state.

FIG. 8 is a schematic diagram illustrating the configuration of a gateway according to a modified example.

FIG. 9 is a table illustrating the correspondence between routing maps stored in the gateway according to the modified example and states of communication lines.

FIG. 10 is a schematic diagram illustrating a configuration example of a first routing map according to the modified example.

FIG. 11 is a schematic diagram illustrating a configuration example of a second routing map according to the modified example.

FIG. 12 is a schematic diagram illustrating a configuration example of a third routing map according to the modified example.

FIG. 13 is a schematic diagram illustrating a configuration example of a fourth routing map according to the modified example.

### DETAILED DESCRIPTION OF PREFERRED EMBODIMENTS

### System Configuration

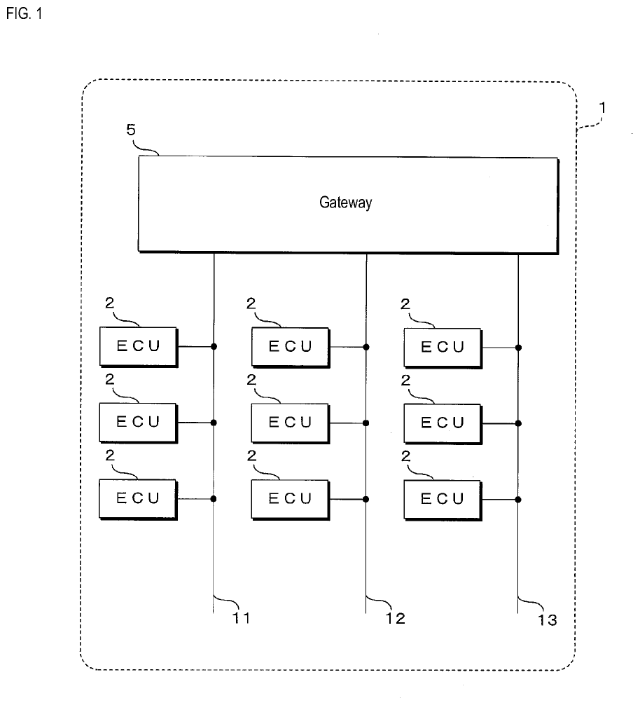

FIG. 1 is a schematic diagram illustrating the configuration of a communication system according to an embodiment of the present disclosure. The communication system according to an embodiment of the present disclosure has a configuration in which a plurality of ECUs 2 mounted in a vehicle 1, which is indicated by the broken line, transmit/receive messages via communication lines 11 to 13 and a gateway 5 mounted in the vehicle 1. Specifically, in the vehicle 1, a plurality of bus-type communication lines 11 to 13 are arranged at appropriate locations, and the communication lines 11 to 13 are connected to the gateway 5. One or more ECUs (electronic control units) 2 are connected to each of the communication lines 11 to 13. The gateway 5 relays messages transmitted/received between ECUs 2 connected to (different communication lines out of) the communication lines 11 to 13 by performing processing for relaying the messages between the communication lines (11 to 13).

For example, the ECUs 2 may include various ECUs such as an ECU for controlling operations of the engine of the vehicle 1, an ECU for locking/unlocking doors, an ECU for turning lights on/off, an ECU for controlling the operation of air-bags, and an ECU for controlling the operation of an ABS (antilock brake system). Each ECU 2 is connected to one of the communication lines 11 to 13 arranged in the vehicle 1, and can transmit/receive messages to/from another ECU 2 via the communication lines 11 to 13 and the gateway 5.

The gateway 5 is connected to the communication lines 11 to 13 that constitute an in-vehicle network of the vehicle 1, and performs processing for relaying messages transmitted/received between the communication lines 11 to 13. In the example shown in FIG. 1, the three communication lines 11 to 13 are connected to the gateway 5, three ECUs 2 are connected to each of the communication lines 11 to 13. However, the number of communication lines (11 to 13) connected to the gateway 5 and the number of ECUs 2 connected to (each of) the communication lines 11 to 13 are exemplary, and there is no limitation thereto. The gateway 5 can relay a message received from one of the communication lines 11 to 13 by transmitting the message to another one of the communication lines 11 to 13.

Note that, in the communication system according to this embodiment, the ECUs 2 and the gateway 5 transmit/receive messages in accordance with the CAN (controller area network) communication protocol. However, a configuration may also be adopted in which the ECUs 2 and the gateway 5 transmit/receive messages in accordance with a communication protocol other than the CAN communication protocol such as the FlexRay or LIN (local interconnect network) communication protocol. It suffices for the ECUs 2 and the gateway 5 to have a configuration in which a message is transmitted/received at least via bus-type communication lines.

### Apparatus Configuration

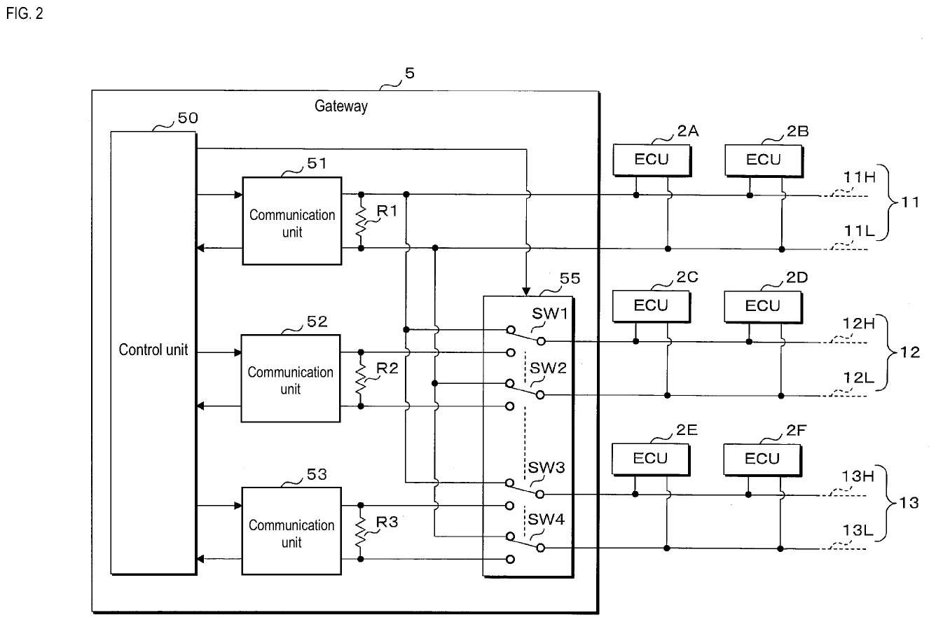

FIG. 2 is a schematic diagram illustrating the configuration of the gateway 5. The gateway 5 according to this embodiment includes a control unit 50, communication units 51 to 53, a bus switching unit 55, and the like. In this embodiment, the CAN communication protocol is adopted, and the communication lines 11 to 13 (so-called CAN buses) that comply with the CAN communication protocol adopt a two-wire system. Therefore, in FIG. 2, the communication line 11 is constituted by two communication lines, namely a first communication line 11H and a second communication line 11L, the communication line 12 is constituted by two communication lines, namely a first communication line 12H and a second communication line 12L, and the communication line 13 is constituted by two communication lines, namely a first communication line 13H and a second communication line 13L. In addition, in FIG. 2, the ECUs are distinguished by ECUs 2 connected to the communication line 11 being denoted as “ECUs 2A and 2B”, ECUs 2 connected to the communication line 12 being denoted as “ECUs 2C and 2D”, and ECUs 2 connected to the communication line 13 being denoted as “ECUs 2E and 2F”.

The communication line 11 is connected to the communication unit 51 of the gateway 5. Also, the first communication line 11H and the second communication line 11L constituting the communication line 11 are connected via a terminating resistor R1, in the vicinity of the communication unit 51. The communication lines 12 and 13 are connected to the bus switching unit 55 of the gateway 5. The bus switching unit 55 has four switches SW1 to SW4, and selectively connects the communication line 12 to the communication line 11 or the communication unit 52 and connects the communication line 13 to the communication line 11 or the communication unit 53, by switching the switches SW1 to SW4.

Specifically, the first communication line 12H of the communication line 12 is connected to the switch SW1 of the bus switching unit 55, and is connected to the first communication line 11H of the communication line 11 or the communication unit 52 by the switch SW1 being switched. Similarly, the second communication line 12L of the communication line 12 is connected to the switch SW2 of the bus switching unit 55, and is connected to the second communication line 11L of the communication line 11 or the communication unit 52 by the switch SW2 being switched. The first communication line 13H of the communication line 13 is connected to the switch SW3 of the bus switching unit 55, and is connected to the first communication line 11H of the communication line 11 or the communication unit 53 by the switch SW3 being switched. The second communication line 13L of the communication line 13 is connected to the switch SW4 of the bus switching unit 55, and is connected to the second communication line 11L of the communication line 11 or the communication unit 53 by the switch SW4 being switched.

The communication unit 52 is connected to the bus switching unit 55 via two communication lines, and these two communication lines are connected via a terminating resistor R2. Similarly, the communication unit 53 is connected to the bus switching unit 55 via two communication lines, and these two communication lines are connected via a terminating resistor R3. The communication units 51 to 53 convert a message that has been supplied from the control unit 50 and is to be transmitted, into a differential signal, and output the differential signal to the communication lines 11 to 13 to transmit the message. In addition, the communication units 51 to 53 receive a message by sampling and acquiring the potential difference between the communication lines 11 to 13, and supply the received message to the control unit 50. Each of the communication units 51 to 53 can be realized by using an IC (integrated circuit) for transmitting/receiving messages based on the CAN communication standard, an IC such as a so-called CAN controller, or the like. The communication units 51 to 53 can switch between a normal operation state where a message is transmitted/received and a power saving state where power consumption is reduced without transmitting/receiving a message, under control of the control unit 50.

The connection state of the four switches SW1 to SW4 of the bus switching unit 55 is switched according to a switching signal supplied from the control unit 50. In this embodiment, the four switches SW1 to SW4 are switched in conjunction with each other according to one switching signal from the control unit 50, but there is no limitation thereto, and a configuration may also be adopted in which the control unit 50 switches the four switches SW1 to SW4 individually. The bus switching unit 55 can connect the communication lines 12 and 13 to the communication line 11 by switching the switches SW1 to SW4 to the communication line 11 side, and thereby achieve the connected state where the three communication lines 11 to 13 are connected directly. Also, the bus switching unit 55 can connect the communication lines 12 and 13 respectively to the communication units 52 and 53 by switching the switches SW1 to SW4 to the communication unit 52 side and the communication unit 53 side, and thereby achieve the separated state where the three communication lines 11 to 13 are connected individually to the respective communication units 51 to 53.

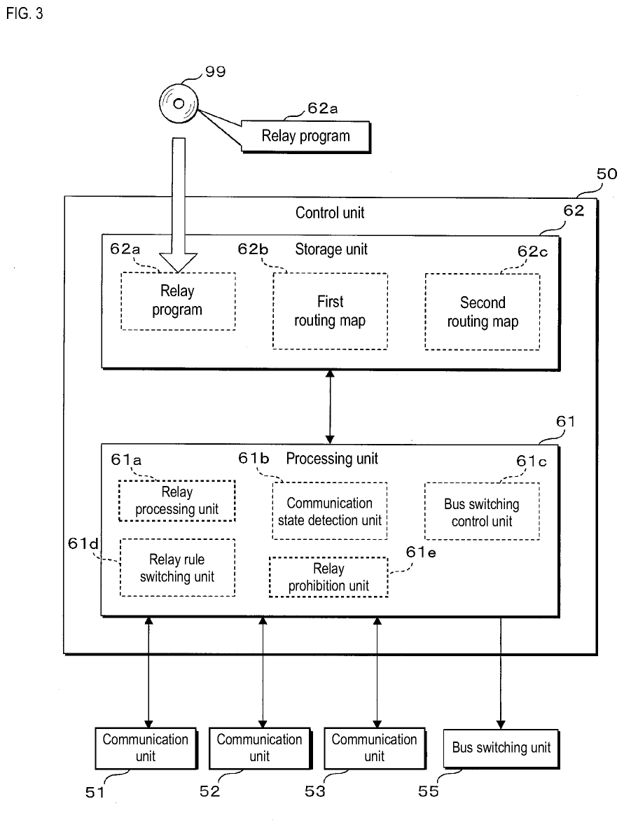

The control unit 50 of the gateway 5 performs relay processing of a message between the communication lines 11 to 13, switching control processing of the bus switching unit 55, and the like. FIG. 3 is a block diagram illustrating the configuration of the control unit 50. The control unit 50 includes a processing unit 61, a storage unit 62, and the like. The processing unit 61 is configured by using an arithmetic processing apparatus such as a CPU (central processing unit) or an MPU (micro-processing unit), and performs arithmetic processing required for message relay processing, switching control processing of the bus switching unit 55, and the like, by reading out and executing a relay program 62a stored in the storage unit 62. The processing unit 61 can transmit/receive messages to/from the communication lines 11 to 13 by sending/receiving messages between the communication units 51 to 53. In addition, the processing unit 61 can switch the communication lines 11 to 13 to the connected state or the separated state by outputting a switching signal to the bus switching unit 55 and switching the four switches SW1 to SW4 of the bus switching unit 55.

The storage unit 62 is configured by using a nonvolatile memory element such as a flash memory or an EEPROM (electrically erasable programmable read only memory). The storage unit 62 stores a program that is executed by the processing unit 61, data required for executing this program, and the like. In this embodiment, the storage unit 62 stores the relay program 62a that is executed by the processing unit 61 and a first routing map 62b and a second routing map 62c that are used for message relay processing. Note that, in this embodiment, when the communication lines 11 to 13 are in the connected state, the bus switching unit 55 uses the first routing map 62b, and when the communication lines 11 to 13 are in the separated state, uses the second routing map 62c.

In addition, in this embodiment, in the processing unit 61, a relay processing unit 61a, a communication state detection unit 61b, a bus switching control unit 61c, a relay rule switching unit 61d, a relay prohibition unit 61e, and the like are realized as software-like functional blocks by executing the relay program 62a. The relay processing unit 61a transmits a message received from one of the communication units 51 to 53, on another one of the communication units 51 to 53, based on the first routing map 62b or the second routing map 62c stored in the storage unit 62, thereby performing processing for relaying the message.

The communication state detection unit 61b performs processing for detecting the communication state of the communication lines 11 to 13 by measuring the amount of messages (the number of bytes, the number of messages, etc.) received on each of the communication units 51 to 53 during a predetermined time period, for example, 1 second or 1 millisecond. If the communication lines 11 to 13 have been switched to the connected state by the bus switching unit 55, it suffices for the communication state detection unit 61b to measure the amount of received messages regarding the communication unit 51 only, since the communication units 52 and 53 are detached from the communication lines 12 and 13. If the communication lines 11 to 13 have been switched to the separated state by the bus switching unit 55, the communication state detection unit 61b individually measures the message amount for each of the communication units 51 to 53.

The bus switching control unit 61c performs processing for switching the switches SW1 to SW4 of the bus switching unit 55 by generating a switching signal depending on the communication state detected by the communication state detection unit 61b, and outputting the switching signal to the bus switching unit 55. When the communication lines 11 to 13 have been switched to the connected state by the bus switching unit 55, if the message amount of the communication unit 51 detected by the communication state detection unit 61b exceeds a predetermined amount, the bus switching control unit 61c performs control for switching the switches SW1 to SW4 of the bus switching unit 55 so as to bring the communication lines 11 to 13 into the separated state. Also, when the communication lines 11 to 13 have been switched to the separated state by the bus switching unit 55, if the message amounts of the communication units 51 to 53 detected by the communication state detection unit 61b are smaller than the predetermined amount, the bus switching control unit 61c performs control for switching the switches SW1 to SW4 of the bus switching unit 55 so as to bring the communication lines 11 to 13 into the connected state.

In addition, when switching the communication lines 11 to 13 from the separated state to the connected state, the bus switching control unit 61c performs control for shifting the communication units 52 and 53 to the power saving state such as a sleep state or a standby state. Accordingly, the communication units 52 and 53 stop processing for transmitting/receiving messages via the communication lines 12 and 13. On the contrary, when the communication lines 11 to 13 are switched from the connected state to the separated state, the bus switching control unit 61c performs control for shifting the communication units 52 and 53 from the power saving state to a normal operation state, in other words a state for performing message transmission/receiving processing.

The relay rule switching unit 61d performs processing for switching the routing map that is used by the relay processing unit 61a for performing relay processing, according to a switch made by the bus switching control unit 61c. When the bus switching control unit 61c switches the communication lines 11 to 13 to the connected state, the relay rule switching unit 61d sets the first routing map 62b stored in the storage unit 62 as a routing map used for relay processing. Also, when the bus switching control unit 61c switches the communication lines 11 to 13 to the separated state, the relay rule switching unit 61d sets the second routing map 62c stored in the storage unit 62, as a routing map used for relay processing.

When the bus switching control unit 61c has switched the communication lines 11 to 13 to the separated state, the relay prohibition unit 61e performs processing for prohibiting the relay processing unit 61a from relaying a message, based on the amount of messages detected by the communication state detection unit 61b during the predetermined time period. The relay prohibition unit 61e prohibits messages received by any communication unit for which the amount of messages during the predetermined time period detected by the communication state detection unit 61b has exceeded the threshold value from being relayed to another one of the communication units 51 to 53.

Note that the “predetermined amount” that is compared with a message amount for the bus switching control unit 61c to perform switching determination and the “threshold value” that is compared with a message amount for the relay prohibition unit 61e to perform prohibition determination may be the same or different values. In this embodiment, the “predetermined amount” and “threshold value” are different values, and the “threshold value” is larger than the “predetermined amount”. In addition, the “predetermined amount” that is compared with a message amount for the bus switching control unit 61c to perform a determination on switching from the connected state to the separated state and the “predetermined amount” that is compared with a message amount in order to make a determination on switching from the separated state to the connected state may be the same or different values. In this embodiment, these two “predetermined amounts” are set to be the same value. In addition, the “predetermined amount” that is compared with a message amount in order to make a determination on switching from the separated state to the connected state may also be different for each of the communication units 51 to 53.

### Switching Between Connected State and Separated State

The gateway 5 according to this embodiment measures the message amount on the communication lines 11 to 13 during the predetermined time period, and if the message amount is smaller than the predetermined amount, brings the communication lines 11 to 13 into the connected state by switching the switches SW1 to SW4 of the bus switching unit 55. In other words, when the communication lines 11 to 13 have been switched to the separated state, and the message amount of each of the communication lines 11 to 13 is smaller than the predetermined amount, the gateway 5 switches the communication lines 11 to 13 from the separated state to the connected state. In this connected state, the three communication lines 11 to 13 are electrically connected, and can be regarded as one communication line. Therefore, all of the ECUs 2 connected to the communication lines 11 to 13 enter a state of being connected to a common communication line, and can directly transmit/receive messages via the common communication line.

In addition, in the connected state, the gateway 5 shifts the communication units 52 and 53 to the power saving state to stop message transmission/receiving processing. In this state, the gateway 5 is not required to perform message relay processing, but the communication unit 51 is required to be operated in order to measure the amount of messages transmitted/received on the common communication line (the communication lines 11 to 13 in the connected state).

If the amount of messages transmitted/received on the common communication line during the predetermined time period exceeds the predetermined amount while the communication lines 11 to 13 are in the connected state, the gateway 5 brings the communication lines 11 to 13 into the separated state by switching the switches SW1 to SW4 of the bus switching unit 55. In addition, the gateway 5 shifts the communication units 52 and 53 from the power saving state to the normal operation state, to cause the communication units 52 and 53 to start message transmission/receiving operations. The gateway 5 performs processing for relaying a message received from one of the communication units 51 to 53, by transmitting the message on another one of the communication units 51 to 53.

In addition, the gateway 5 according to this embodiment relays messages based on a routing map. When control for switching the communication lines 11 to 13 to the connected state or the separated state is performed by switching the switches SW1 to SW4 of the bus switching unit 55 as described above, the configuration of the network constituted by the communication lines 11 to 13 changes. Therefore, the gateway 5 has two routing maps, namely the first routing map 62b and the second routing map 62c stored in the storage unit 62, and switches a routing map used for message relay processing according to switching of the bus switching unit 55.

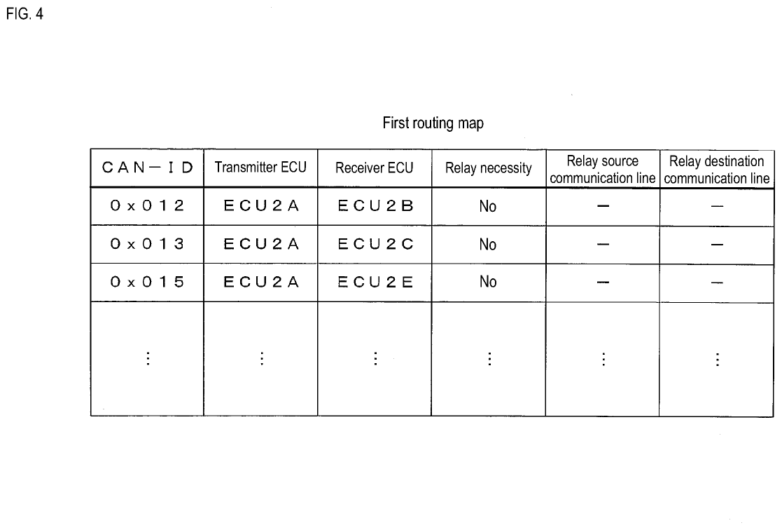

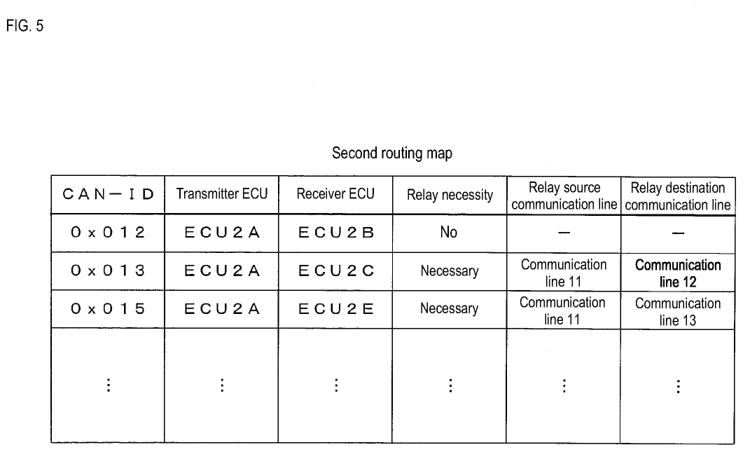

FIG. 4 is a schematic diagram illustrating a configuration example of the first routing map 62b. FIG. 5 is a schematic diagram illustrating a configuration example of the second routing map 62c. In the first routing map 62b and the second routing map 62c, information such as IDs of the CAN (CAN-IDs) assigned to messages, ECUs that transmit a message (transmitter ECUs), ECUs to receive a message (receiver ECUs), whether or not a message needs to be relayed (relay necessity), communication lines of message relay sources (relay source communication lines), and communication lines of message relay destinations (relay destination communication lines) are stored in association with each other. Note that the examples shown in FIGS. 4 and 5 are based on the network configuration illustrated in FIG. 2, and a plurality of ECUs 2 connected to the communication lines 11 to 13 are distinguished using reference signs 2A to 2F shown in FIG. 2.

In this example, a message to which 0x012 (hexadecimal) is assigned as the CAN-ID is a message that needs to be transmitted by the ECU 2A connected to the communication line 11, and received by the ECU 2B connected to communication line 11. A message to which 0x013 is assigned as the CAN-ID is a message that needs to be transmitted by the ECU 2A connected to the communication line 11, and received by the ECU 2C connected to the communication line 12. A message to which 0x015 is assigned as the CAN-ID is a message that needs to be transmitted by the ECU 2A connected to the communication line 11, and received by the ECU 2E connected to the communication line 13.

When the communication lines 11 to 13 are in the connected state, the gateway 5 performs relay processing using the first routing map 62b illustrated in FIG. 4. Note that, in this example, in the connected state, the communication lines 11 to 13 are all electrically connected, and the gateway 5 is not required to relay a message. Therefore, in the first routing map 62b, regarding messages of all of the CAN-IDs, “no” is set in “relay necessity”. When the communication lines 11 to 13 are all in the connected state and the gateway 5 is not required to relay a message as in this example, the first routing map 62b is not required to be stored in the storage unit 62.

When the communication lines 11 to 13 are in the separated state, the gateway 5 performs relay processing using the second routing map 62c illustrated in FIG. 5. In the second routing map 62c, regarding a message to which 0x12 is assigned as the CAN-ID, since both the ECU 2A that transmits the message and the ECU 2B that receives the message are connected to the communication line 11, and the message can be transmitted/received directly between the ECUs 2A and 2B, “no” is set in “relay necessity”, and the gateway 5 does not relay this message. Regarding a message to which 0x13 is assigned as the CAN-ID, since the ECU 2A that transmits the message is connected to the communication line 11 and the ECU 2C that receives the message is connected to the communication line 12, “necessary” is set in “relay necessity”, and the gateway 5 relays this message from the communication line 11 to the communication line 12. Regarding a message to which 0x15 is assigned as the CAN-ID, since the ECU 2A that transmits the message is connected to the communication line 11 and the ECU 2E that receives the message is connected to the communication line 13, “necessary” is set in “relay necessity”, and the gateway 5 relays this message from the communication line 11 to the communication line 13.

By the gateway 5 switching a routing map used for message relay processing according to a switch between the connected state and the separated state of the communication lines 11 to 13 made by the bus switching unit 55 in this manner, message relay processing can be appropriately performed for a change in the network configuration constituted by the communication lines 11 to 13. Note that, in this example, a configuration is adopted in which, when the communication lines 11 to 13 are in the connected state, a message does not need to be relayed, but there is no limitation thereto, and, for example, a configuration may also be adopted in which only the communication lines 11 and 12 are connected in the connected state, and the communication line 13 is not connected, and, in such a case, in the first routing map 62b, appropriate values are set in order to relay a message between an ECU 2 connected to the communication line 11 or 12 and an ECU 2 connected to the communication line 13.

### Flowchart

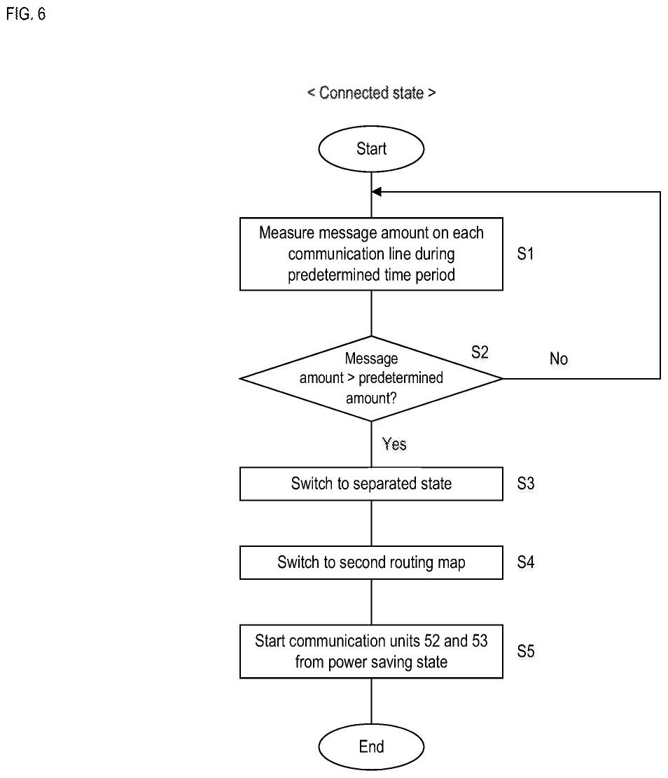

FIG. 6 is a flowchart illustrating a procedure of processing that is performed by the gateway 5 when the communication lines 11 to 13 are in the connected state. The communication state detection unit 61b of the processing unit 61 of the control unit 50 of the gateway 5 according to this embodiment measures the amount of messages received by the communication unit 51 during a predetermined time period (step S1). Next, the bus switching control unit 61c of the processing unit 61 determines whether or not the message amount measured in step S1 exceeds a predetermined amount (step S2). If the message amount does not exceed the predetermined amount (step S2: NO), the processing unit 61 returns the procedure to step S1, and repeatedly performs the measurement of a message amount and the determination that is based on the predetermined amount.

When the message amount during the predetermined time period exceeds the predetermined amount (step S2: YES), the bus switching control unit 61c switches the switches SW1 to SW4 by outputting a switching signal to the bus switching unit 55, so as to switch the communication lines 11 to 13 to the separated state (step S3). In addition, the relay rule switching unit 61d of the processing unit 61 switches the routing map used for relay processing from the first routing map 62b to the second routing map 62c (step S4). Moreover, the processing unit 61 shifts the communication units 52 and 53 connected to the communication lines 12 and 13 from the power saving state to the normal operation state by switching the bus switching unit 55 (step S5), and ends the procedure in the connected state.

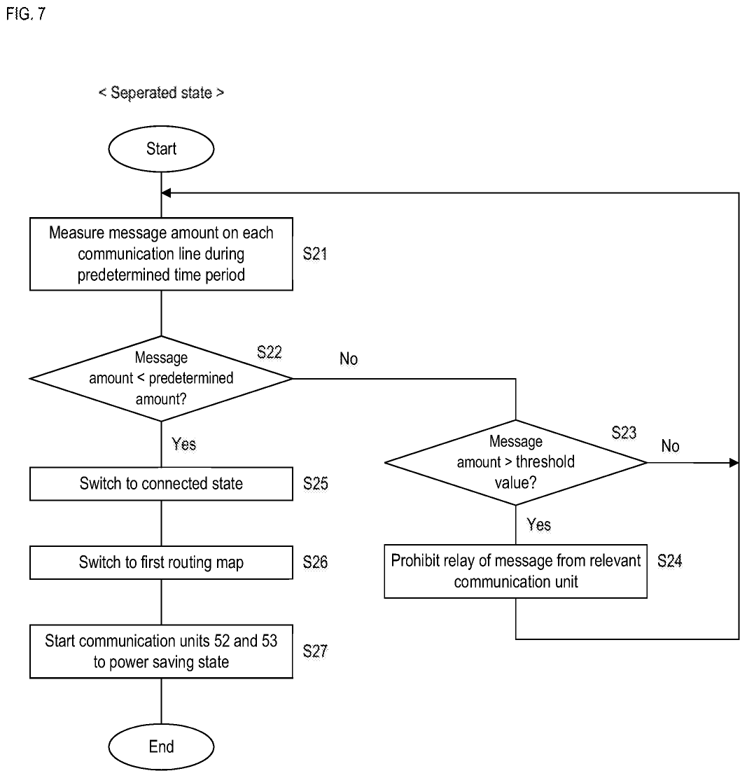

FIG. 7 is a flowchart illustrating a procedure of processing that is performed by the gateway 5 when the communication lines 11 to 13 are in the separated state. The communication state detection unit 61b of the processing unit 61 of the control unit 50 of the gateway 5 according to this embodiment measures the amount of messages received by each of the communication units 51 to 53 during the predetermined time period (step S21). Next, the bus switching control unit 61c of the processing unit 61 determines whether or not the message amount of each of the communication units 51 to 53 measured in step S21 is smaller than the predetermined amount (step S22). If a message amount of at least one of the communication units 51 to 53 is larger than or equal to the predetermined amount (step S22: NO), the relay prohibition unit 61e of the processing unit 61 further determines whether or not the message amount measured in step S21 exceeds the threshold value (>the predetermined amount) (step S23). If the message amount exceeds the threshold value (step S23: YES), the relay prohibition unit 61e prohibits relay of a message received from a communication unit in which the message amount exceeds the threshold value from among the communication units 51 to 53 (step S24), and returns the procedure to step S21. If the message amount does not exceed the threshold value (step S23: NO), the relay prohibition unit 61e returns the procedure to step S21.

If the message amount is smaller than the predetermined amount in all of the communication units 51 to 53 (step S22: YES), the bus switching control unit 61c switches the switches SW1 to SW4 by outputting a switching signal to the bus switching unit 55, so as to switch the communication lines 11 to 13 to the connected state (step S25). In addition, the relay rule switching unit 61d of the processing unit 61 switches the routing map used for relay processing from the second routing map 62c to the first routing map 62b (step S26). In addition, the processing unit 61 shifts the communication units 52 and 53 detached from the communication lines 12 and 13 by the bus switching unit 55 being switched, from the normal operation state to the power saving state (step S27), and ends the procedure in the separated state.

### Overview

The communication system according to this embodiment that has the above-described configuration switches the three communication lines 11 to 13 connected to the gateway 5 to the connected state where the three communication lines are directly connected or the separated state where the three communication lines are separated apart, using the switches SW1 to SW4 of the bus switching unit 55. On the directly connected communication lines 11 to 13, each of the ECUs 2 connected to the communication lines 11 to 13 can directly transmit/receive a message to/from another ECU 2 without the gateway 5 relaying the message. Therefore, if a switch is made to the connected state by the bus switching unit 55, the communication units 52 and 53 that transmit/receive a message to/from the communication lines 11 to 13 do not need to operate, and it is possible to shift the communication system to a power saving state and reduce the power consumption. In addition, if the message amount increases on the communication lines 11 to 13 that have been switched to the connected state, the communication load can be distributed and reduced by the communication lines 11 to 13 being switched to the separated state by the bus switching unit 55.

Such connection and separation of the communication lines 11 to 13 change the network configuration in the communication system. Therefore, the gateway 5 switches the message relay rule according to the network configuration, in other words the switching state of the bus switching unit 55. Specifically, the gateway 5 has a plurality of routing maps in which messages and relay destinations of the messages are associated, and that are stored in the storage unit 62, and selects and uses the first routing map 62b or the second routing map 62c stored in the storage unit 62 according to the switching state of the bus switching unit 55, so as to perform message relay.

In addition, the gateway 5 detects the communication state of the communication lines 11 to 13, for example, a message amount during a predetermined time period, and switches the switches SW1 to SW4 of the bus switching unit 55 depending on the detected communication state. At this time, the gateway 5 detects a common communication state regarding the communication lines 11 to 13 in a connected state, and individually detects communication states regarding the communication lines 11 to 13 in a separated state. For example, the gateway 5 switches the bus switching unit 55 to bring the communication lines 11 to 13 into the connected state if the message amount is smaller than a predetermined amount, and bring the communication lines 11 to 13 into the separated state if the message amount exceeds the predetermined amount. If the message amount is small, the power consumption of a communication IC and the like that constitute the communication units 52 and 53 is reduced by switching the communication lines 11 to 13 to the connected state, and if the message amount is large, the communication load can be distributed and reduced by switching the communication lines 11 to 13 to the separated state.

In addition, after switching the switches SW1 to SW4 of the bus switching unit 55 to the separated state due to the message amount exceeding the predetermined amount, the gateway 5 detects a message amount of each of the separated communication lines 11 to 13. If there is a communication line on which the detected message amount exceeds a threshold value (a second predetermined amount) from among the communication lines 11 to 13, the gateway 5 prohibits relay of a message received from this communication line, to another one of the communication lines 11 to 13. Accordingly, if an unauthorized communication apparatus connected to one of the communication lines 11 to 13 delivers an attack of transmitting a large amount of messages, it is possible to reduce the influence on the entire system by removing this communication line from the communication system.

Note that, in this embodiment, a configuration is adopted in which the gateway 5 uses the switches SW1 to SW4 of the bus switching unit 55 to switch between a state where the three communication lines 11 to 13 are all connected and a state where the three communication lines 11 to 13 are all separated, but there is no limitation thereto. For example, a configuration may also be adopted in which the gateway 5 is capable of switching the switches SW1 and SW2 of the bus switching unit 55 independently, and switching the switches SW3 and SW4 independently, and a switch can be made to a state where the communication lines 11 and 12 are connected and the communication line 13 is separated, a state where the communication lines 11 and 13 are connected and the communication line 12 is separated, or the like. In addition, in this case, the gateway 5 has routing maps that are based on respective switching states, and are stored in the storage unit 62.

In addition, a configuration is adopted in which the three communication lines 11 to 13 are connected to the gateway 5, but there is no limitation thereto, and a configuration may also be adopted in which two communication lines or four or more communication lines are connected. In addition, the configurations, the set values and the like of the routing maps shown in FIGS. 4 and 5 are exemplary, and there is no limitation thereto. In addition, the communication system according to this embodiment is mounted in the vehicle 1, but there is no limitation thereto. The communication system may also be mounted in a mobile body such as a vessel or an aircraft instead of the vehicle 1, and may also be installed in a household, a factory, a school, an office, or the like instead of a mobile body.

In addition, a configuration is adopted in which the gateway 5 switches the switches SW1 to SW4 of the bus switching unit 55 according to the message amount on the communication lines 11 to 13 during the predetermined time period, but there is no limitation thereto, and a configuration may also be adopted in which a switch is made under another condition. For example, a configuration can be adopted in which the gateway 5 switches the switches SW1 to SW4 of the bus switching unit 55 according to the on/off state of an IG (ignition) switch of the vehicle 1. In this configuration, for example, when the IG switch is off, the gateway 5 brings the communication lines 11 to 13 into the connected state, and when the IG switch is on, brings the communication lines 11 to 13 into the separated state. Accordingly, when the IG switch is switched off, and the engine of the vehicle 1 is stopped, the gateway 5 can switch the communication lines 11 to 13 to the connected state, shift the communication units 52 and 53 to the power saving state, and reduce the consumption of power stored in a battery of the vehicle 1. In addition, when it is highly likely that the message amount will increase since the IG switch has been switched on and ECUs 2 mounted in the vehicle 1 are operated, the gateway 5 can distribute the communication load by switching the communication lines 11 to 13 to the separated state.

Note that FIG. 3 illustrates the relay program 62a being stored in the storage unit 62, but if processing is realized as a dedicated IC incorporated in a hardware-like manner, unlike the configuration of a CPU that performs processing as a result of the processing unit 61 executing a program, the relay program 62a is not required to be stored in the storage unit 62. If a configuration is adopted in which the processing unit 61 reads out and executes the relay program 62a stored in the storage unit 62, this relay program 62a may be written directly in the storage unit 62 before being mounted on a circuit substrate during a manufacturing process of the gateway 5, for example, or may also be written using a communication function of the gateway 5. In addition, for example, a configuration may also be adopted in which the relay program 62a is provided after being recorded in a recording medium 99 such as a memory card or an optical disk, is read out from the recording medium 99 through a memory card slot provided in the gateway 5 or the vehicle 1, or an apparatus such as an optical disk drive, and is written to the storage unit 62.

### Modified Example

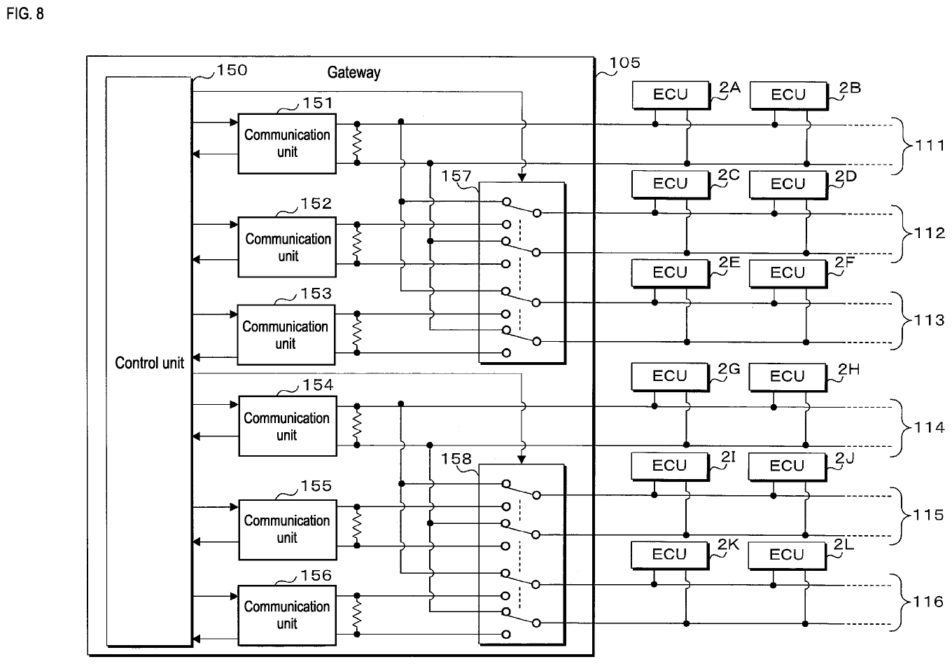

FIG. 8 is a schematic diagram illustrating the configuration of a gateway 105 according to a modified example. Six communication lines 111 to 116 are connected to the gateway 105 according to the modified example. ECUs 2A and 2B are connected to the communication line 111, ECUs 2C and 2D are connected to the communication line 112, and ECUs 2E and 2F are connected to the communication line 113. ECUs 2G and 2H are connected to the communication line 114, ECUs 2I and 2J are connected to the communication line 115, and ECUs 2K and 2L are connected to the communication line 116.

The gateway 105 according to the modified example includes a control unit 150, six communication units 151 to 156, and two bus switching units 157 and 158. The configuration of the gateway 105 according to the modified example is equivalent to a configuration consisting of two switching control configurations that are the same as the configuration of switching control that is performed by the communication units 51 to 53 and the bus switching unit 55 of the gateway 5 illustrated in FIG. 2. Specifically, the gateway 105 according to the modified example switches the communication lines 111 to 113 between the connected state and the separated state using the communication units 151 to 153 and the bus switching unit 157, and switches the communication lines 114 to 116 between the connected state and the separated state using the communication units 154 to 156 and the bus switching unit 158.

The control unit 150 of the gateway 105 according to the modified example causes the communication units 151 to 153 to detect the message amounts on the communication lines 111 to 113, and performs control for switching the communication lines 111 to 113 to the connected state or the separated state by switching the switches of the bus switching unit 157 according to this detection result. Also, the control unit 150 causes the communication units 154 to 156 to detect the message amounts on the communication lines 114 to 116, and performs control for switching the communication lines 114 to 116 to the connected state or the separated state by switching the switches of the bus switching unit 158 according to this detection result.

Note that the control unit 150 can independently control switching between the connected state and the separated state of the communication lines 111 to 113 and switching between the connected state and the separated state of the communication lines 114 to 116. However, in message relay processing that is performed by the control unit 150, a message received from one of the six communication lines 111 to 116 can be relayed to any of the six communication lines 111 to 116. Therefore, the control unit 150 of the gateway 105 according to the modified example has four routing maps stored in the storage unit according to combinations of the connected state or the separated state of the communication lines 111 to 113 and the connected state or the separated state of the communication lines 114 to 116.

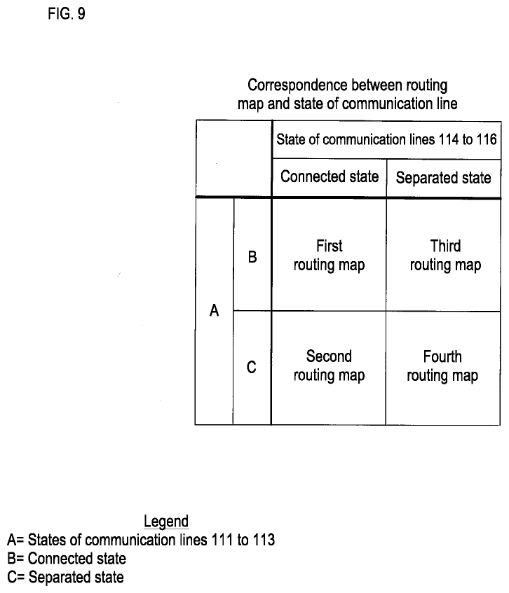

FIG. 9 is a table illustrating the correspondence between routing maps stored in the gateway 105 according to the modified example and the states of the communication lines 111 to 116. The gateway 105 according to the modified example stores four routing maps, namely first to fourth routing maps. When the communication lines 111 to 113 are in the connected state and the communication lines 114 to 116 are in the connected state, the gateway 105 performs message relay processing using the first routing map. When the communication lines 111 to 113 are in the separated state and the communication lines 114 to 116 are in the connected state, the gateway 105 performs message relay processing using the second routing map. When the communication lines 111 to 113 are in the connected state and the communication lines 114 to 116 are in the separated state, the gateway 105 performs message relay processing using the third routing map. When the communication lines 111 to 113 are in the separated state and the communication lines 114 to 116 are in the separated state, the gateway 105 performs message relay processing using the fourth routing map.

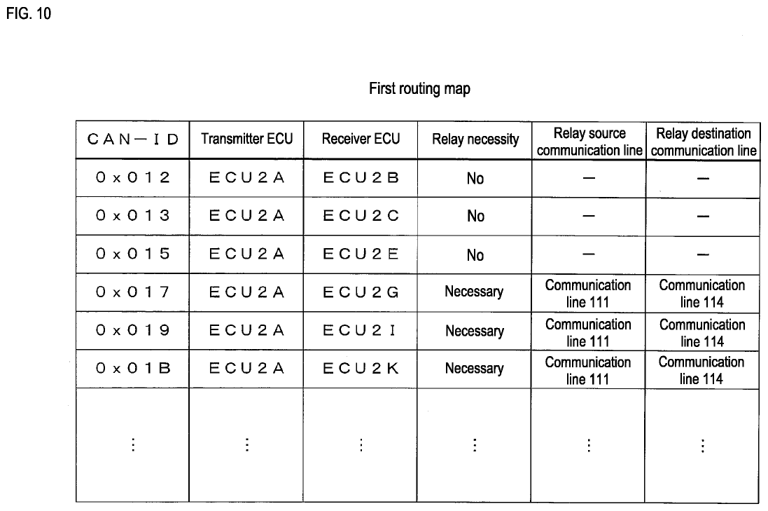

FIG. 10 is a schematic diagram illustrating a configuration example of the first routing map according to the modified example. When the communication lines 111 to 113 are in the connected state and the communication lines 114 to 116 are in the connected state, the gateway 105 according to the modified example performs message relay processing using the first routing map illustrated in FIG. 10. Since the communication lines 111 to 113 are in the connected state and the communication lines 114 to 116 are in the connected state, this state of the communication system is substantially the same as a state where the ECUs 2A to 2L are connected to two communication lines. A message transmitted by the ECU 2A connected to one communication line, namely the communication line 111 is directly received by the ECUs 2B to 2F without being relayed by the gateway 105, or relayed by the gateway 105 and received by the ECUs 2G to 2L connected to the other communication line, namely the communication line 114.

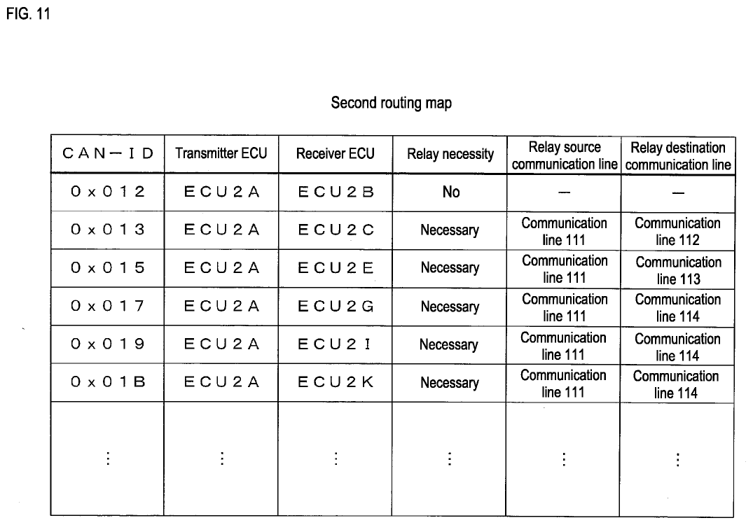

FIG. 11 is a schematic diagram illustrating a configuration example of the second routing map according to the modified example. When the communication lines 111 to 113 are in the separated state and the communication lines 114 to 116 are in the connected state, the gateway 105 according to the modified example performs message relay processing using the second routing map illustrated in FIG. 11. Since the communication lines 111 to 113 are in the separated state and the communication lines 114 to 116 are in the connected state, this state of the communication system is substantially the same as a state where the ECUs 2A to 2L are connected to four communication lines. A message transmitted by the ECU 2A connected to the communication line 111 is directly received by the ECU 2B connected to the communication line 111 without being relayed by the gateway 105, is relayed by the gateway 105 and received by the ECUs 2C to 2F connected to the communication line 112 or 113, or is relayed by the gateway 105 and received by the ECUs 2G to 2L connected to the communication line 114 in the connected state.

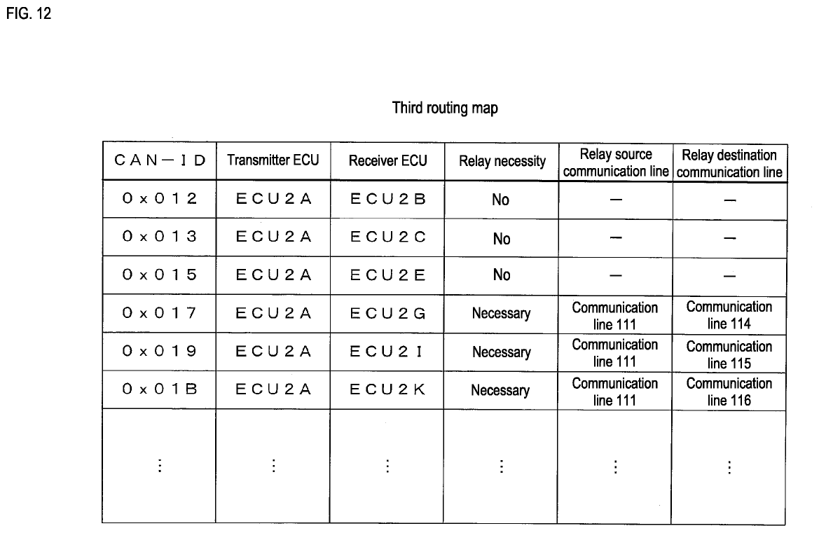

FIG. 12 is a schematic diagram illustrating a configuration example of the third routing map according to the modified example. When the communication lines 111 to 113 are in the connected state and the communication lines 114 to 116 are in the separated state, the gateway 105 according to the modified example performs message relay processing using the third routing map illustrated in FIG. 12. Since the communication lines 111 to 113 are in the connected state and the communication lines 114 to 116 are in the separated state, this state of the communication system is substantially the same as a state where the ECUs 2A to 2L are connected to four communication lines. A message transmitted by the ECU 2A connected to the communication line 111 is directly received by the ECUs 2B to 2F without being relayed by the gateway 105, or is relayed by the gateway 105 and received by the ECUs 2G to 2L each connected to one of the communication lines 114 to 116.

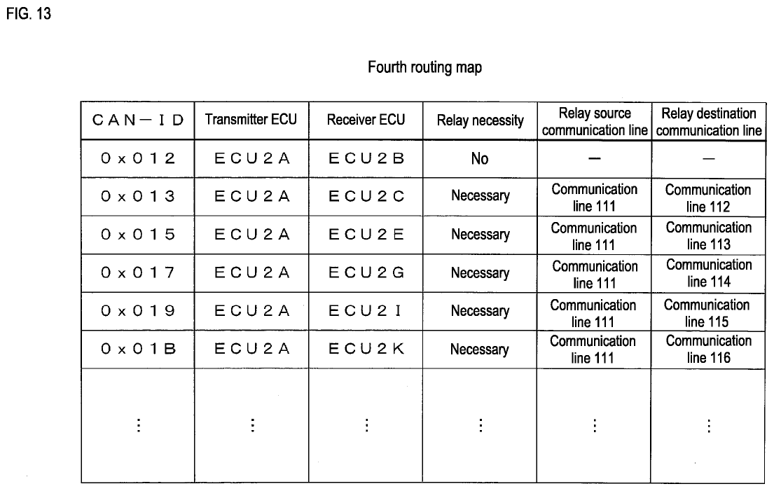

FIG. 13 is a schematic diagram illustrating a configuration example of the fourth routing map according to the modified example. When the communication lines 111 to 113 are in the separated state and the communication lines 114 to 116 are in the separated state, the gateway 105 according to the modified example performs message relay processing using the fourth routing map illustrated in FIG. 13. The communication lines 111 to 116 are all in the separated state, and thus, in the communication system in this state, the gateway 105 relays messages between the six communication lines 111 to 116.

The above-described gateway 105 according to the modified example is configured to switch between the connected state and the separated state of the six communication lines 111 to 116 divided into two groups each including three communication lines. The number of communication lines, the number of groups of communication lines, and the like, for which the gateway switches between the connected state and the separated state, are not limited to those described in this modified example, and various configurations can be adopted.

1. A relay apparatus comprising:
a relay unit to which a plurality of communication lines are connected, and that is configured to relay a message received from one communication line, by transmitting the message on another communication line;
a switch for switching between a connected state where at least two communication lines included in the plurality of communication lines are connected and a separated state where the communication lines are separated apart; and
a relay rule switching unit for switching a message relay rule for the relay unit depending on a switching state of the switch.

2. The relay apparatus according to claim 1, further comprising
a communication state detection unit configured to detect a communication state of the communication lines,
wherein the switch is switched in accordance with the communication state detected by the communication state detection unit.

3. The relay apparatus according to claim 2,
wherein the communication state detection unit is configured to detect an amount of messages transmitted/received via the communication lines, and
if the message amount is smaller than a predetermined amount, the switch is switched to the connected state, and
if the message amount exceeds the predetermined amount, the switch is switched to the separated state.

4. The relay apparatus according to claim 3, further comprising:
a relay prohibition unit configured to prohibit the relay unit from relaying a message received from a communication line for which a message amount detected by the communication state detection unit after the switch has been switched to the separated state exceeds a second predetermined amount, to another communication line.

5. The relay apparatus according to claim 1, further comprising:
a storage unit configured to store a plurality of sets of relay information in which a message and a relay destination of the message are associated,
wherein a message relay rule is switched by reading out one set of the relay information from the storage unit depending on a switching state of the switch.

6. A relay method, wherein a relay apparatus, to which a plurality of communication lines are connected, and that relays a message received from one communication line, by transmitting the message on another communication line:
switches between a connected state where at least two communication lines included in the plurality of communication lines are connected and a separated state where the communication lines are separated apart, and
switches a message relay rule depending on a switching state.

7. A relay program that causes a relay apparatus that includes a relay unit to which a plurality of communication lines are connected, and that relays a message received from one communication line, by transmitting the message on another communication line, and a switch for switching between a connected state where at least two communication lines included in the plurality of communication lines are connected and a separated state where the communication lines are separated apart,
to switch the switch depending on a communication state of the communication lines, and
to switch a message relay rule for the relay unit depending on a switching state of the switch.

8. The relay apparatus according to claim 2, further comprising:
a storage unit configured to store a plurality of sets of relay information in which a message and a relay destination of the message are associated,
wherein a message relay rule is switched by reading out one set of the relay information from the storage unit depending on a switching state of the switch.

9. The relay apparatus according to claim 3, further comprising:
a storage unit configured to store a plurality of sets of relay information in which a message and a relay destination of the message are associated,
wherein a message relay rule is switched by reading out one set of the relay information from the storage unit depending on a switching state of the switch.

10. The relay apparatus according to claim 4, further comprising:
a storage unit configured to store a plurality of sets of relay information in which a message and a relay destination of the message are associated,
wherein a message relay rule is switched by reading out one set of the relay information from the storage unit depending on a switching state of the switch.
